(19) United States
(12) Patent Application Publication
(10) Pub. No.: US 2026/0104604 A1
(43) Pub. Date: Apr. 16, 2026

(54) SEMICONDUCTOR DEVICE AND METHOD FOR MANUFACTURING THE SAME

(71) Applicant: TAIWAN SEMICONDUCTOR MANUFACTURING COMPANY LTD., HSINCHU (TW)

(72) Inventors: KUO-PIN CHANG, HSINCHU COUNTY (TW); YU-WEI TING, TAIPEI CITY (TW); KUO-CHING HUANG, HSINCHU CITY (TW); HUNG-JU LI, HSINCHU CITY (TW)

(21) Appl. No.: 18/916,761

(22) Filed: Oct. 16, 2024

(51) Int. Cl. G02F 1/01; G02F 1/015

(52) U.S. Cl. CPC G02F 1/0147; G02F 1/0152

(57) ABSTRACT

A semiconductor device and a method for manufacturing the semiconductor device are provided. The method comprises: providing a substrate; depositing a first silicon layer on the substrate, the first silicon layer including a first type portion, a second type portion, and an intrinsic portion disposed therebetween; depositing a second silicon layer on the first silicon layer; depositing a phase change material on the second silicon layer; forming a photoresist on the phase change material; and etching the phase change material and the second silicon layer to form a silicon structure and a phase change material layer.

### BACKGROUND

Waveguides generally use silicon-based resonator modulators with a PN structure to modulate wavelengths through the electro-optical effect, which alters the effective refractive index (n) at the junction. To achieve low power consumption, a high extinction ratio, low insertion loss and a small footprint, an improved resonator modulator is needed. Also, improper waveguide structures affect modulation loss, extinction ratio and modulation efficiency of the resonator.

### BRIEF DESCRIPTION OF THE DRAWINGS

Aspects of the embodiments of the present disclosure are best understood from the following detailed description when read with the accompanying figures. It should be noted that, in accordance with the standard practice in the industry, various structures are not drawn to scale. In fact, the dimensions of the various structures may be arbitrarily increased or reduced for clarity of discussion.

FIG. 1A is a top view of a semiconductor device, in accordance with some embodiments of the present disclosure.

FIG. 1B is a cross-sectional view of a semiconductor device, in accordance with some embodiments of the present disclosure.

FIG. 1C is a cross-sectional view of a semiconductor device, in accordance with some embodiments of the present disclosure.

FIG. 1D is a cross-sectional view of a semiconductor device, in accordance with some embodiments of the present disclosure.

FIG. 1E is a cross-sectional view of a semiconductor device, in accordance with some embodiments of the present disclosure.

FIG. 2A is a top view of a semiconductor substrate, in accordance with some embodiments of the present disclosure.

FIG. 2B is a cross-sectional view of a semiconductor substrate, in accordance with some embodiments of the present disclosure.

FIG. 2C is a top view of a semiconductor substrate, in accordance with some embodiments of the present disclosure.

FIG. 2D is a cross-sectional view of a semiconductor substrate, in accordance with some embodiments of the present disclosure.

FIG. 3A is a top view of a semiconductor substrate, in accordance with some embodiments of the present disclosure.

FIG. 3B is a cross-sectional view of a semiconductor substrate, in accordance with some embodiments of the present disclosure.

FIG. 4A is a graph showing a refractive index versus a temperature of a waveguide of a semiconductor device, in accordance with some embodiments of the present disclosure.

FIG. 4B is a graph showing a refractive index difference versus a power of a heater of a semiconductor device, in accordance with some embodiments of the present disclosure.

FIG. 4C is a graph showing a wavelength difference versus a power density of a waveguide of a semiconductor device, in accordance with some embodiments of the present disclosure.

FIGS. 5A to 5I illustrate a method of manufacturing a semiconductor device according to some embodiments of the present disclosure.

FIGS. 6A to 6J illustrate a method of manufacturing a semiconductor device according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, although terms such as “first,” “second” and “third” describe various elements, components, regions, layers and/or sections, these elements, components, regions, layers and/or sections should not be limited by these terms. These terms may only be used to distinguish one element, component, region, layer or section from another. Terms such as “first,” “second” and “third” when used herein do not imply a sequence or order unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately” and “about” generally mean within a value or range that can be contemplated by people having ordinary skill in the art. Alternatively, the terms “substantially,” “approximately” and “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

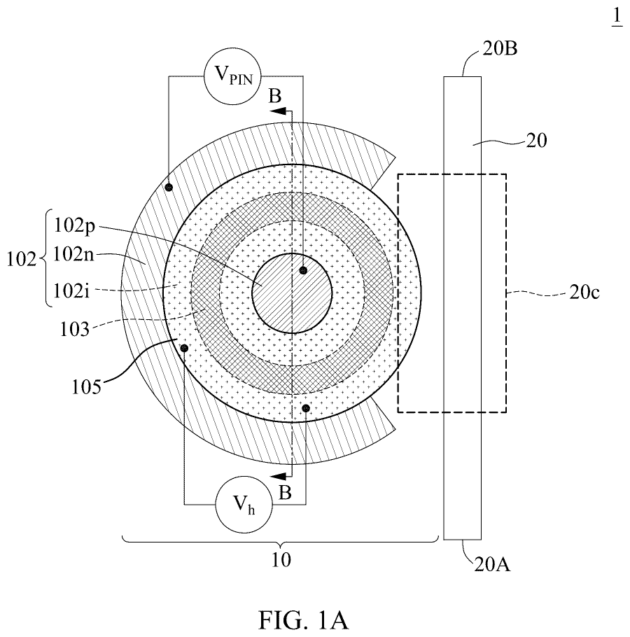

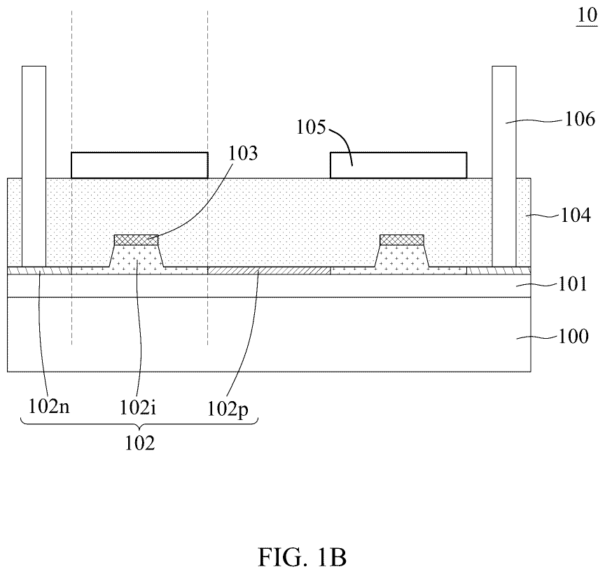

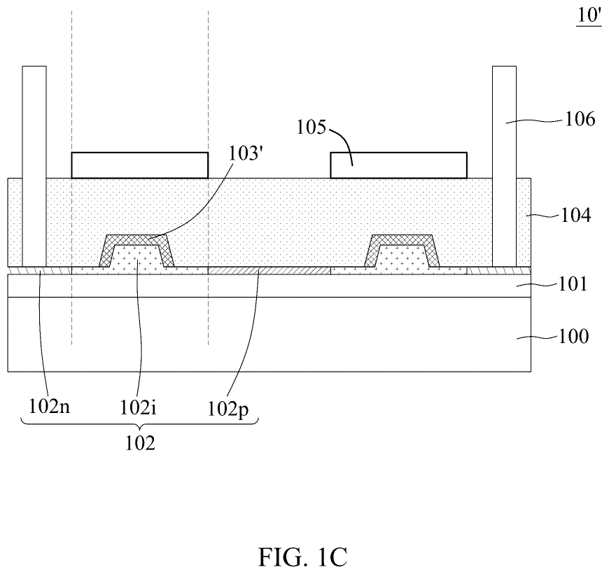

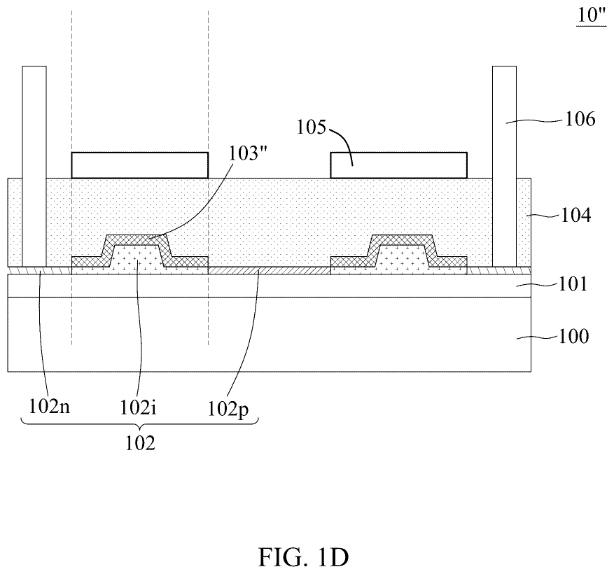

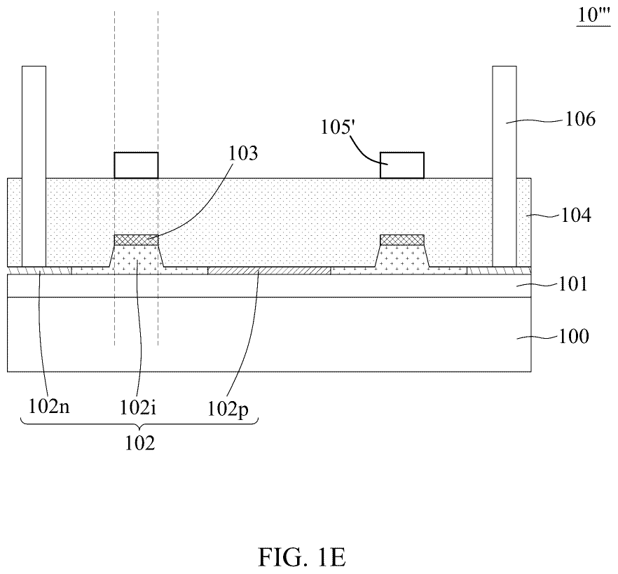

FIG. 1A is a cross-sectional view of a semiconductor device 1 in accordance with some embodiments of the present disclosure. The semiconductor device 1 may be an optical device. In some embodiments, the semiconductor device 1 is a waveguide. The semiconductor device 1 includes a ring waveguide 10 and a bus waveguide 20.

In some embodiments, the ring waveguide 10 has various shapes, for example, a loop of any shape (e.g., circular loop, oval loop, rounded rectangular loop, rounded square loop, rounded triangular loop, etc.). By way of example, the annular waveguide may have an elongated loop shape (e.g., a racetrack shape).

The bus waveguide 20 includes an input portion 20A and an output portion 20B. An optical signal (e.g., light inputted from the input portion 20A) may be supplied to the bus waveguide 20 of the semiconductor device 1 via the input portion 20A and the optical signal having an input wavelength approaching a desired resonant wavelength of the ring waveguide 10 may be coupled to the ring waveguide 10.

The bus waveguide 20 is disposed adjacent to the ring waveguide 10. The bus waveguide 20 is disposed sufficiently close to the ring waveguide 10 to provide evanescent coupling through a coupling region 20c. The coupling region 20c is between the input portion 20A and the output portion 20B of the bus waveguide 20. The light may input to the ring waveguide 10 through the coupling region 20c.

The ring waveguide 10 may include a PIN structure 102, a wavelength-adjusting component 103, and a heater 105. A heating voltage (Vₕ) may be applied to the heater 105.

The wavelength-adjusting component 103 may have various shapes corresponding to the ring waveguide 10, for example, a loop of any shape (e.g., circular loop, oval loop, rounded rectangular loop, rounded square loop, rounded triangular loop, etc.).

The heater 105 may have various shapes corresponding to the ring waveguide 10, for example, a loop of any shape (e.g., circular loop, oval loop, rounded rectangular loop, rounded square loop, rounded triangular loop, etc.).

The PIN structure 102 includes an n-type doped portion 102n, a p-type doped portion 102p, and an intrinsic portion 102i disposed therebetween. Throughout the present disclosure, the n-type and p-type doped portions may refer to first type and second type doped portions or vice versa. The PIN structure 102 may be a micro-ring resonator modulator (MRM). The PIN structure 102 may be a semiconductor-based optical micro-ring resonator modulator suitable for several applications such as a micro-ring modulator, a micro-ring laser, and a micro-ring filter. The wavelength-adjusting component 103 may be a phase change material (PCM) layer.

The PIN structure 102 may include highly doped portions. For example, the dopant concentration may be around 1310¹⁸ cm⁻³ to 9310¹⁸ cm⁻³. The p⁺/n⁺ doping percentage may be adjusted based on modulation requirements. The dopant concentration may be around 4310¹⁸ cm⁻³ to 7310¹⁸ cm⁻³. The dopant concentration may be around 5310¹⁸ cm⁻³ to 8310¹⁸ cm⁻³. The dopant concentration may be around 6310¹⁸ cm⁻³ to 9310¹⁸ cm⁻³. The n-type doped portion 102n may be an n⁺ region. The p-type doped portion 102p may be a p⁺ region. The arrangement of the highly doped portions and an intrinsic portion of the PIN structure 102 may enhance the modulation performance. Under the operations of the ring waveguide 10, the refractive index of the ring waveguide 10 increases with an increase of the wavelength of the light absorbed by the ring waveguide 10. The PIN structure 102 is biased or reverse-biased to a bias voltage (V_{PIN}). When the bias voltage changes, the free carrier density in the PIN structure 102 also changes, which in turn changes an original refractive index of the ring waveguide 10 to the effective refractive index (n). The optical signal with the wavelength inputted from the bus waveguide 20 may be mostly confined within the ring waveguide 10. Thus, by changing the bias voltage, the PIN structure 102 of the ring waveguide 10 can be controlled to resonate at the resonance wavelength λ (i.e., the desired wavelength). In other words, the optical signal is modulated to the resonance wavelength λ by applying the bias voltage to the PIN structure 102 of the ring waveguide 10.

In addition, the refractive index of the ring waveguide 10 may be affected by temperature. The heater 105 may provide thermal energy to the PIN structure 102 by applying a heating voltage (V_{g}). When the heater 105 provides the thermal energy during a time period, the thermal energy may assist to compensate the original refractive index of the environment of the PIN structure 102 of the ring waveguide 10, such that the original refractive index of the environment of the PIN structure 102 may be corrected to the effective refractive index (n). Accordingly, the PIN structure 102 of the ring waveguide 10 may resonate at the resonance wavelength λ.

FIG. 1B is a cross-sectional view of the ring waveguide 10 of the semiconductor device 1 along line B-B of FIG. 1A, in accordance with some embodiments of the present disclosure.

One or both of the ring waveguide 10 and the bus waveguide 20 may be formed on a substrate 100. The substrate 100 may be made of one or more semiconductor materials including, but not limited to, silicon (Si), indium phosphide (InP), germanium (Ge), gallium arsenide (GaAs), silicon carbide (SiC), aluminum gallium arsenide (AlGaAs), indium gallium arsenide (InGaAs), indium arsenide (InAs), or combinations thereof. For illustration purposes, in FIG. 1A, the ring waveguide 10 is similarly described as being composed of silicon.

The ring waveguide 10 may include a dielectric layer 101 disposed on the substrate 100. The dielectric layer 101 may be a base oxide layer which may be formed by oxidizing the substrate 100. For example, with a silicon substrate 100, the dielectric layer 101 may be silicon dioxide (SiO₂) (which may be formed in the presence of oxygen at a temperature in the range from 900° C. to 1380° C.). In some examples, the dielectric layer 101 may be a buried oxide (BOX) layer in the substrate 100. For example, and depending on the application, a layer of the SiO₂ may be buried in the substrate 100 at a depth from the wafer surface ranging from less than 100 nm to several micrometers.

The PIN structure 102 is disposed on the dielectric layer 101. The intrinsic portion 102i is disposed between the n-type doped portion 102n and the p-type doped portion 102p. The intrinsic portion 102i has a mesa structure. The mesa structure of the intrinsic portion 102i tapers from a bottom of the mesa structure toward a top of the mesa structure. The mesa structure of the intrinsic portion 102i may increase the area for receiving thermal energy from the heater 105.

A conductive via 106 is disposed on the n-type doped portion 102n. The conductive via 106 is electrically connected to the n-type doped portion 102n. Another conductive via 106 (which is not shown here) may also be disposed on and electrically connected to the p-type doped portion 102p. The bias voltage (V_{PIN}) may be applied to the PIN structure 102 through the conductive vias 106.

A dielectric layer 104 is disposed on the dielectric layer 101. The dielectric layer 104 covers the PIN structure 102. The dielectric layer 104 may be formed over exposed portions of the ring waveguide 10 and the PIN structure 102. In some embodiments, the dielectric layer 104 includes at least one of SiO₂, Si₃N₄, SiONₓ, Al₂O₃, HfO₂, polyimide, BCB, and the like.

The heater 105 is disposed on the dielectric layer 104. The heater 105 is separated from the PIN structure 102 and the wavelength-adjusting component 103 through the dielectric layer 104. The heater 105 aligns the PIN structure 102. A width of the heater 105 and a width of the PIN structure 102 are substantially the same. The mesa structure of the intrinsic portion 102i is directly under the heater 105. The wavelength-adjusting component 103 is directly under the heater 105. A projective area of the intrinsic portion 102i of the PIN structure 102 is covered in a projective area of the heater 105. The heater 105 is electrically connected to a power so as to provide thermal energy to the environment of the ring waveguide 10. In some embodiments, the heater 105 provides thermal energy to the dielectric layer 101, the PIN structure 102, the wavelength-adjusting component 103, and the dielectric layer 104. By receiving the thermal energy from the heater 105, the wavelength-adjusting component 103 may efficiently correct the original refractive index of the ring waveguide 10 to the effective refractive index (n).

The wavelength-adjusting component 103 is disposed on the intrinsic portion 102i. In some embodiments, the wavelength-adjusting component 103 includes the phase change material layer. The wavelength-adjusting component 103 may completely cover the top of the mesa structure of the intrinsic portion 102i. The wavelength-adjusting component 103 may partially cover the top of the mesa structure of the intrinsic portion 102i. A perpendicular central line of the wavelength-adjusting component 103 may substantially align with a perpendicular central line of the mesa structure of the intrinsic portion 102i.

In some embodiments, the wavelength-adjusting component 103 includes any one of GeTe, GeSbTe₂₂₅, GeSbSeTe, VO₂, Sb₂S₃, and Sb₂Se₃. The wavelength-adjusting component 103 may include any one of GeTe, GeSbTe₂₂₅, GeSbSeTe, VO₂, Sb₂S₃, and Sb₂Se₃ doped with carbon, nitrogen, Al, Ag, or W. A thickness of the wavelength-adjusting component 103 may have a range from 0.01 nm to 100 nm. A thickness of the wavelength-adjusting component 103 may have a range from 0.01 nm to 1 nm. A thickness of the wavelength-adjusting component 103 may have a range from 1 nm to 5 nm. A thickness of the wavelength-adjusting component 103 may have a range from 5 nm to 10 nm. A thickness of the wavelength-adjusting component 103 may have a range from 10 nm to 20 nm. A thickness of the wavelength-adjusting component 103 may have a range from 20 nm to 30 nm. A thickness of the wavelength-adjusting component 103 may have a range from 30 nm to 50 nm. A thickness of the wavelength-adjusting component 103 may have a range from 50 nm to 100 nm.

As discussed previously, a phase change material is introduced into the ring waveguide 10. Since the wavelength-adjusting component 103 is more sensitive to thermal energy than a silicon-based material, it can control the PIN structure 102 of the total cavity of the ring waveguide 10 to reach the effective refractive index (n) more precisely and efficiently than the silicon-based material. Under the same thermal condition, the wavelength-adjusting component 103 is more sensitive than the PIN structure 102 composed of silicon. Accordingly, the wavelength-adjusting component 103 may significantly impact the environment of the PIN structure 102 based on thermal energy, such that the effective refractive index (n) can be quickly reached. Also, both the extinction ratio and the bandwidth of the ring waveguide 10 may be increased. To achieve the effective refractive index or the resonance wavelength λ of the ring waveguide 10, a ratio of operative temperatures of the wavelength-adjusting component 103 to the ring waveguide 10 is around 1/50. A ratio of operative powers of the wavelength-adjusting component 103 to the ring waveguide 10 is around 1/50. Compared with the silicon-based material, the characteristics of the wavelength-adjusting component 103 significantly improve the performance of the ring waveguide 10. That is, with a slight change in environmental temperature, the wavelength-adjusting component 103 itself can quickly and significantly adjust the original refractive index of the ring waveguide 10 to reach a desired value (i.e., the effective refractive index (n)).

During operations, the heater 105 is applied with the heating voltage (Vₕ) to increase the environmental temperature of the ring waveguide 10. The heating voltage may be a short-time bias voltage. The heater 105 is configured to heat the wavelength-adjusting component 103 from a low temperature to a high temperature. The wavelength-adjusting component 103 is configured to adjust a wavelength of an optical signal in the PIN structure 102 based on thermal energy received from the heater 105. The wavelength-adjusting component 103 is configured to receive thermal energy from the heater 105 to change from an amorphous state to a crystalline state. Once the lattice orientation of the wavelength-adjusting component 103 is changed from a low to a high temperature, its phase is correspondingly changed from the amorphous state to the crystalline state and will be maintained at the crystalline state. Such phase transition of the wavelength-adjusting component 103 will affect the electrical and thermal characteristics of the PIN structure 102. Such phase transition of the wavelength-adjusting component 103 will affect the electrical and thermal characteristics of the ring waveguide 10. Also, the phase transition of the wavelength-adjusting component 103 will significantly affect the degree of variation in the refractive index compared with the environmental temperature of the ring waveguide 10.

Since the ring waveguide 10 has the wavelength-adjusting component 103 with the aforesaid excellent characteristics, an entire thickness of the ring waveguide 10 may be reduced. For example, a thickness of the dielectric layer 104 may have a range from 200 nm to 800 nm. Also, the PIN structure 102 of the ring waveguide 10 may have a small footprint. For example, a width of the PIN structure 102 may have a range from 600 nm to 1000 nm.

FIG. 1C is a cross-section view of a ring waveguide 10′, in accordance with some embodiments of the present disclosure. The structure of the ring waveguide 10′ is similar to the structure of the ring waveguide 10 of FIG. 1B, except that a wavelength-adjusting component 103′ extends from the top of the mesa structure of the intrinsic portion 102i to the bottom of the mesa structure of the intrinsic portion 102i. The wavelength-adjusting component 103′ surrounds the mesa structure of the intrinsic portion 102i.

In some embodiments, the wavelength-adjusting component 103′ includes a first portion covering the top of the mesa structure of the intrinsic portion 102i and a second portion covering sidewalls of the mesa structure of the intrinsic portion 102i. A thickness of the first portion the wavelength-adjusting component 103′ may be the same as a thickness of the second portion the wavelength-adjusting component 103′. In some embodiments, the thickness of the first portion the wavelength-adjusting component 103′ is greater than the thickness of the second portion the wavelength-adjusting component 103′.

FIG. 1D is a cross-section view of a ring waveguide 10″, in accordance with some embodiments of the present disclosure. The structure of the ring waveguide 10″ is similar to the structure of the ring waveguide 10 of FIG. 1B, except that a wavelength-adjusting component 103″ extends from the top of the mesa structure of the intrinsic portion 102i to the periphery of the intrinsic portion 102i. The wavelength-adjusting component 103″ surrounds the mesa structure of the intrinsic portion 102i. The wavelength-adjusting component 103″ completely covers the intrinsic portion 102i.

A projective area of the wavelength-adjusting component 103″ is substantially the same as a projective area of the heater 105. The arrangement of the wavelength-adjusting component 103″ may facilitate receiving thermal energy from the heater 105 and shorten the time when the ring waveguide 10″ reaches the effective refractive index (n).

In some embodiments, the wavelength-adjusting component 103″ includes a first portion covering the top of the mesa structure of the intrinsic portion 102i, a second portion covering sidewalls of the mesa structure of the intrinsic portion 102i, and a third portion covering a top surface of the intrinsic portion 102i. The wavelength-adjusting component 103″ may have a uniform thickness. That is, the thicknesses of the first, second, and third portions are substantially the same.

FIG. 1E is a cross-section view of a ring waveguide 10″′, in accordance with some embodiments of the present disclosure. The structure of the ring waveguide 10′″ is similar to the structure of the ring waveguide 10 of FIG. 1B, except that a heater 105′ exactly aligns with the wavelength-adjusting component 103.

A width of the heater 105′is substantially the same as a width of the wavelength-adjusting component 103. A projective area of the wavelength-adjusting component 103 is substantially the same as a projective area of the heater 105′. The projective area of the heater 105′ is covered in a projective area of the PIN structure 102. According to the arrangement, since a size of the heater 105′ is less than a size of the heater 105, under the supply of the heating voltage (Vₕ), the ring waveguide 10′″ has a minimum power consumption.

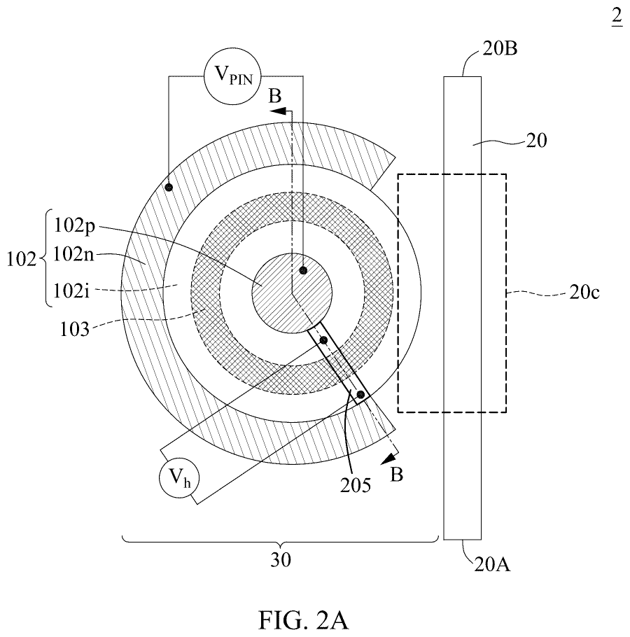

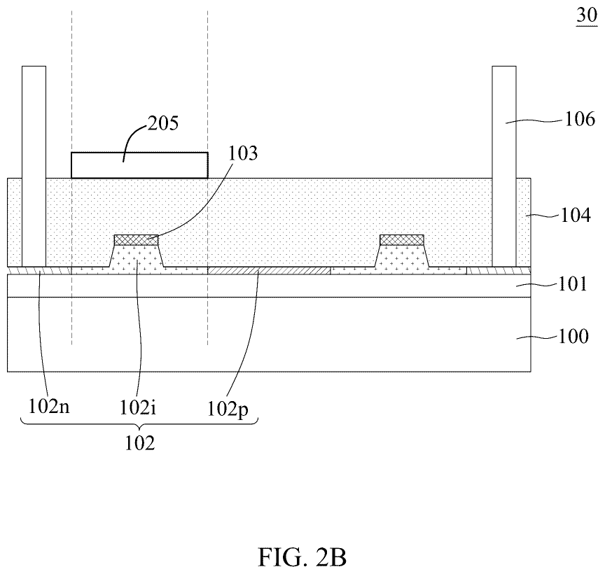

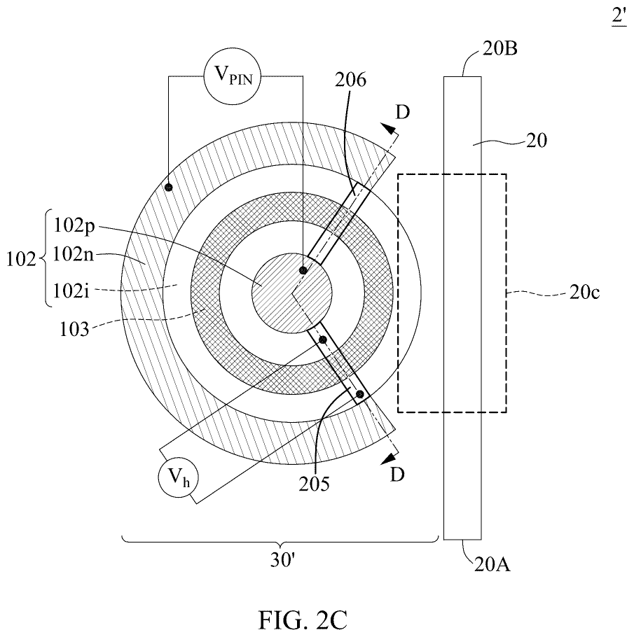

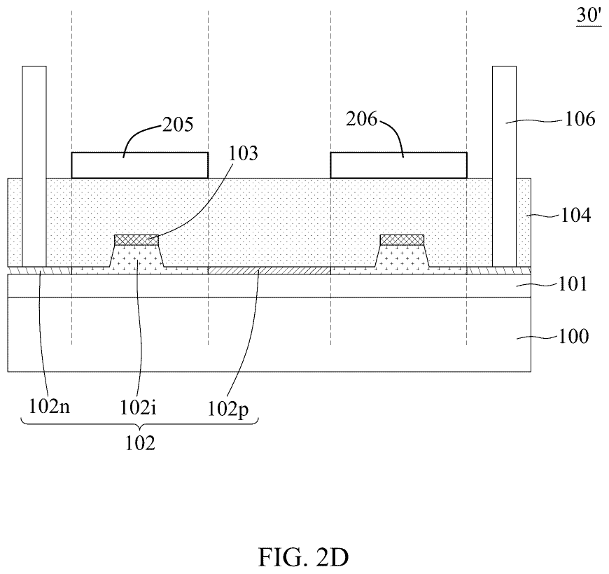

FIG. 2A is a top view of a semiconductor device 2 in accordance with some embodiments of the present disclosure. The semiconductor device 2 may be an optical device. In some embodiments, the semiconductor device 2 is a waveguide. The semiconductor device 2 includes a ring waveguide 30 and a bus waveguide 20. The structure of the semiconductor device 2 is similar to the structure of the semiconductor device 1 of FIG. 1A, except that a heater 205 of the ring waveguide 30 has a rectangular shape rather than a circular loop.

Similar to the ring waveguide 10, the ring waveguide 30 may have various shapes, for example, a loop of any shape (e.g., circular loop, oval loop, rounded rectangular loop, rounded square loop, rounded triangular loop, etc.). By way of example, the annular waveguide may have an elongated loop shape (e.g., a racetrack shape).

The wavelength-adjusting component 103 may have various shapes corresponding to the ring waveguide 30, for example, a loop of any shape (e.g., circular loop, oval loop, rounded rectangular loop, rounded square loop, rounded triangular loop, etc.).

The heater 205 may have various shapes, including rectangular, square, trapezoidal, and polygonal. The heater 205 only occupies a small area.

FIG. 2B is a cross-section view of the ring waveguide 30 along line B-B of FIG. 2A, in accordance with some embodiments of the present disclosure. The structure of the ring waveguide 30 is similar to the structure of the ring waveguide 10 of FIG. 1B, except that the heater 205 is only disposed on the left side of the ring waveguide 30.

Although the environment of the ring waveguide 30 may be heated by the heater 205 unevenly, such arrangement may reduce power consumption.

FIG. 2C is a top view of a semiconductor device 2′ in accordance with some embodiments of the present disclosure. The structure of the semiconductor device 2′ is similar to the structure of the semiconductor device 2 of FIG. 2A, except that a ring waveguide 30′ of the semiconductor device 2′ also has a heater 206. Each of the heaters 205, 206 has a rectangular shape rather than a circular loop.

Similar to the ring waveguide 10, the ring waveguide 30′ may have various shapes, for example, a loop of any shape (e.g., circular loop, oval loop, rounded rectangular loop, rounded square loop, rounded triangular loop, etc.). By way of example, the annular waveguide may have an elongated loop shape (e.g., a racetrack shape).

The wavelength-adjusting component 103 may have various shapes corresponding to the ring waveguide 30′, for example, a loop of any shape (e.g., circular loop, oval loop, rounded rectangular loop, rounded square loop, rounded triangular loop, etc.).

Each of the heaters 205, 206 may have various shapes, including rectangular, square, trapezoidal, and polygonal. The heaters 205 and 206 only occupy a small area.

FIG. 2D is a cross-section view of the ring waveguide 30′ along line D-D of FIG. 2C, in accordance with some embodiments of the present disclosure. The structure of the ring waveguide 30′ is similar to the structure of the ring waveguide 30 of FIG. 2B, except that the heaters 205, 206 are disposed on the left and right sides of the ring waveguide 30, respectively.

Compared with the structure of the ring waveguide 30 of FIG. 2A, the environment of the ring waveguide 30′ may be heated by the heaters 205, 206 more evenly.

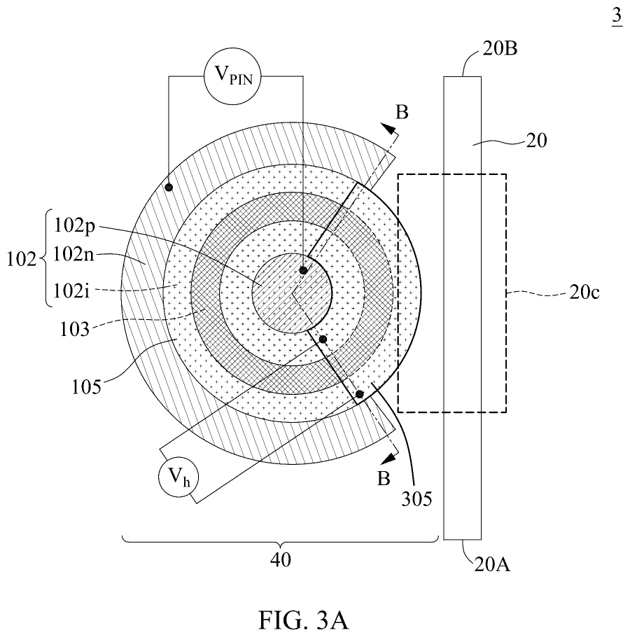

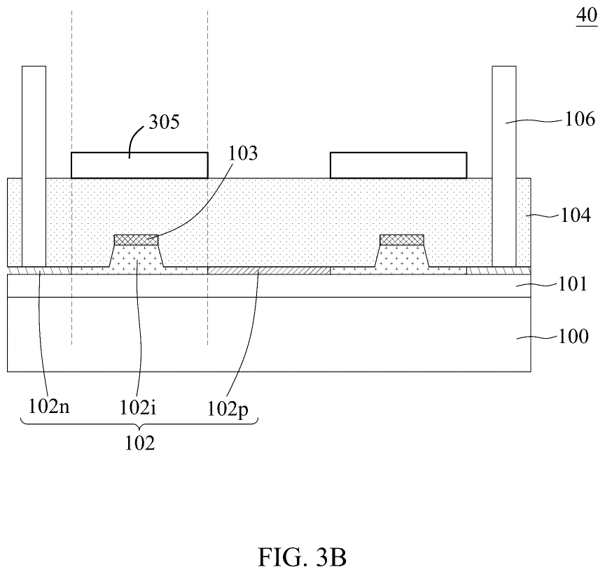

FIG. 3A is a top view of a semiconductor device 3 in accordance with some embodiments of the present disclosure. The semiconductor device 3 may be an optical device. In some embodiments, the semiconductor device 3 is a waveguide. The semiconductor device 3 includes a ring waveguide 40 and a bus waveguide 20. The structure of the semiconductor device 3 is similar to the structure of the semiconductor device 1 of FIG. 1A, except that a heater 305 of the ring waveguide 40 has a non-closed loop, such as a fan shape, a sector shape, a quarter circular shape, or an arc shape.

Similar to the ring waveguide 10, the ring waveguide 40 may have various shapes, for example, a loop of any shape (e.g., circular loop, oval loop, rounded rectangular loop, rounded square loop, rounded triangular loop, etc.). By way of example, the annular waveguide may have an elongated loop shape (e.g., a racetrack shape).

The wavelength-adjusting component 103 may have various shapes corresponding to the ring waveguide 40, for example, a loop of any shape (e.g., circular loop, oval loop, rounded rectangular loop, rounded square loop, rounded triangular loop, etc.).

The heater 305 of the ring waveguide 40 is disposed adjacent to the bus waveguide 20. The heater 305 partially covers the PIN structure 102. The heater 305 partially covers the wavelength-adjusting component 103.

FIG. 3B is a cross-section view of the ring waveguide 40 along line B-B of FIG. 3A, in accordance with some embodiments of the present disclosure. The structure of the ring waveguide 30 is similar to the structure of the ring waveguide 10 of FIG. 1B, except that the heater 305 covers a portion of the PIN structure 102 of the ring waveguide 30 adjacent to the bus waveguide 20.

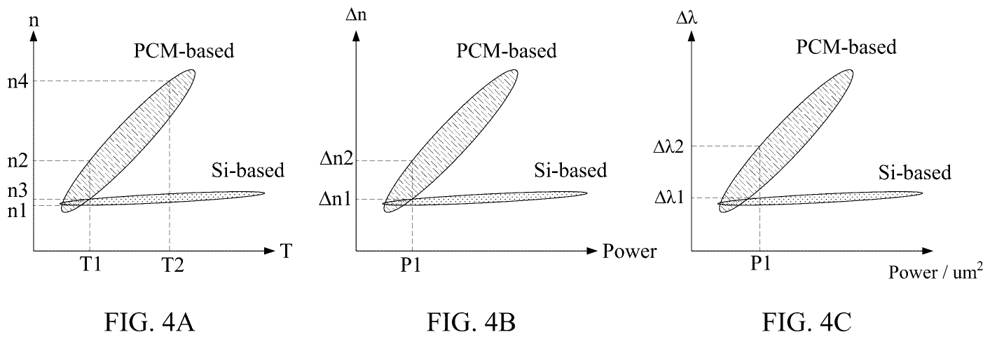

FIG. 4A is a graph showing a refractive index (n) versus a temperature of a waveguide of a semiconductor device, in accordance with some embodiments of the present disclosure. For example, the waveguide of the semiconductor device may correspond to the ring waveguide 10 of the semiconductor device 1.

As shown in the graph, when the environmental temperature of the waveguide is T1, the refractive index of the Si-based material is n1 and the refractive index of the PCM-based material is n2, wherein n2 is significantly greater than n1. This indicates that when the PCM-based material is applied to the waveguide, the PCM-based material may easily adjust the waveguide to reach the desired value (e.g., n_{eff}) at a relatively low environmental temperature. Compared with the PCM-based material, when the Si-based material is applied to the waveguide, the Si-based material may make the waveguide reach the desired value (e.g., n_{eff}) at a relatively high environmental temperature, which may waste power consumption.

Accordingly, FIG. 4A shows that a first refractive index shifting sensitivity (i.e., n4-n2) of the wavelength-adjusting component 103 is greater than a second refractive index shifting sensitivity (i.e., n3-n1) of the intrinsic portion 102i.

FIG. 4B is a graph showing a refractive index difference (Δn) versus a power of a heater of a semiconductor device, in accordance with some embodiments of the present disclosure. For example, the waveguide of the semiconductor device may correspond to the ring waveguide 10 of the semiconductor device 1, and the heater may correspond to the heater 105.

As shown in the graph, when the power applied to the heater is P1, the refractive index difference of the Si-based material is Δn1 and the refractive index difference of the PCM-based material is Δn2, wherein Δn2 is significantly greater than Δn1. This indicates that when the PCM-based material is applied to the waveguide, the PCM-based material may quickly change the characteristic of the waveguide from a relatively low refractive index to a relatively high refractive index at a relatively low power. Compared with the PCM-based material, when the Si-based material is applied to the waveguide, the Si-based material has to change the characteristic of the waveguide from a relatively low refractive index to a relatively high refractive index at a relatively high power.

FIG. 4C is a graph showing a wavelength difference (Δλ) versus a power density of a waveguide of a semiconductor device, in accordance with some embodiments of the present disclosure. For example, the waveguide of the semiconductor device may correspond to the ring waveguide 10 of the semiconductor device 1.

As shown in the graph, when the power density applied to the heater is P1, the wavelength difference of the Si-based material is Δλ1 and the refractive index difference of the PCM-based material is Δλ2, wherein Δλ2 is significantly greater than Δλ1. This indicates that when the PCM-based material is applied to the waveguide, the PCM-based material may quickly change the characteristic of the waveguide from a relatively low wavelength to a relatively high wavelength at a relatively low power density. Compared with the PCM-based material, when the Si-based material is applied to the waveguide, the Si-based material has to change the characteristic of the waveguide from a relatively low wavelength to a relatively high wavelength at a relatively high power density.

Accordingly, FIG. 4C shows that a first wavelength shifting sensitivity (i.e., Δλ2) of the wavelength-adjusting component 103 is greater than a second wavelength shifting sensitivity (i.e., Δλ1) of the intrinsic portion 102i.

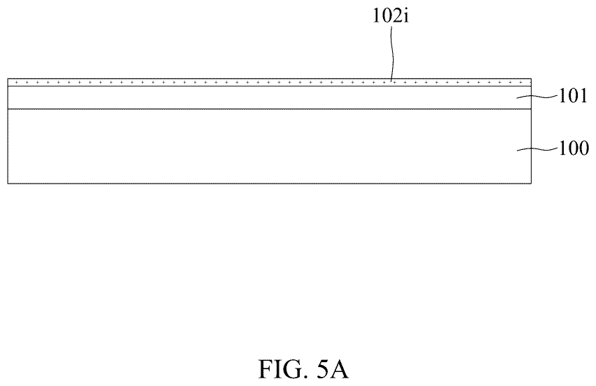

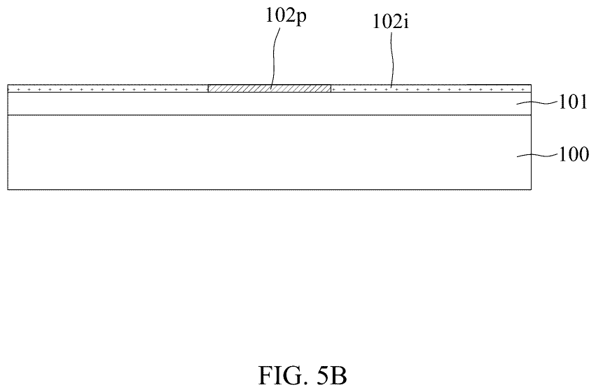

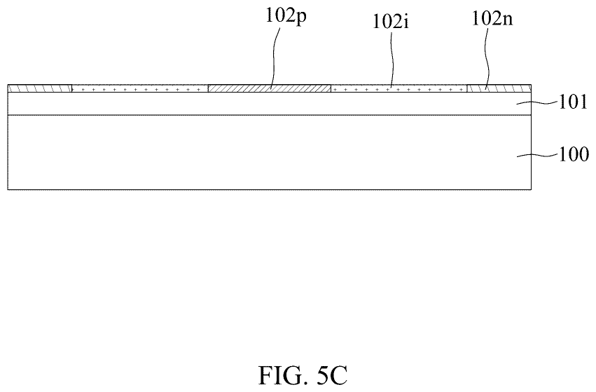

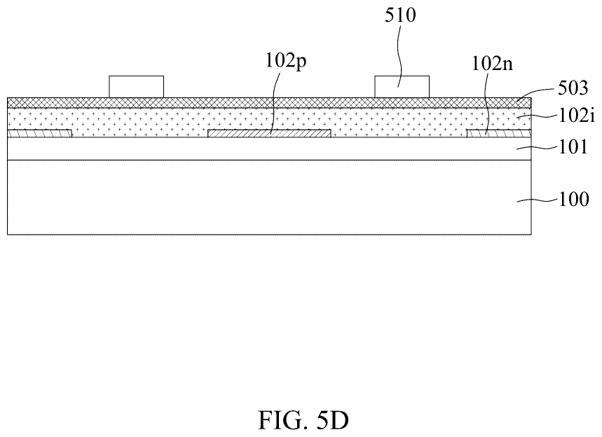

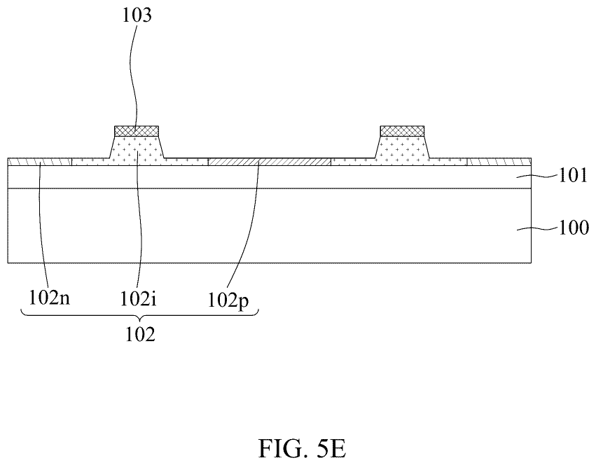

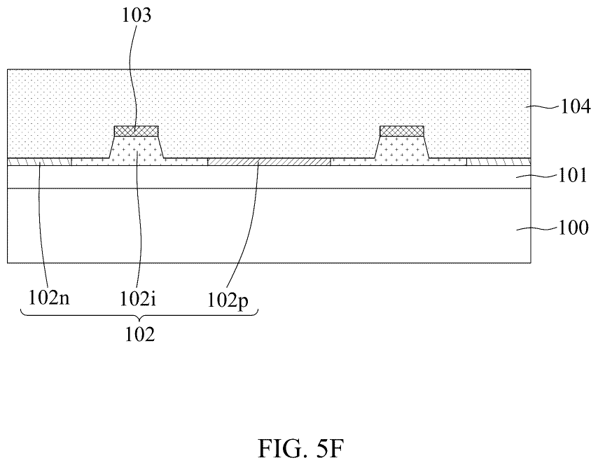

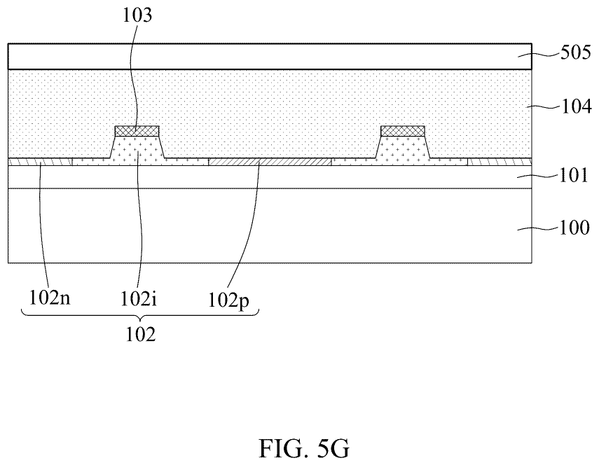

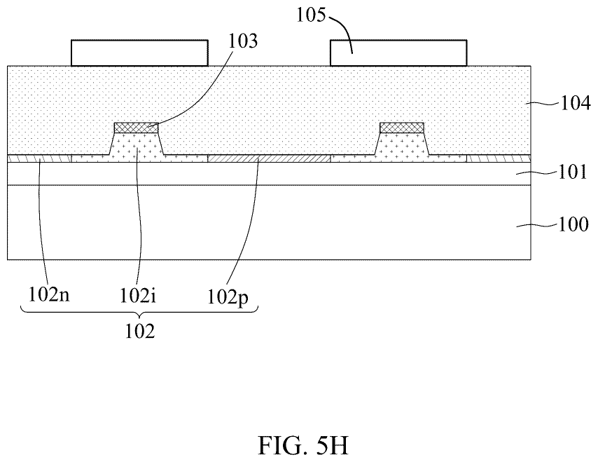

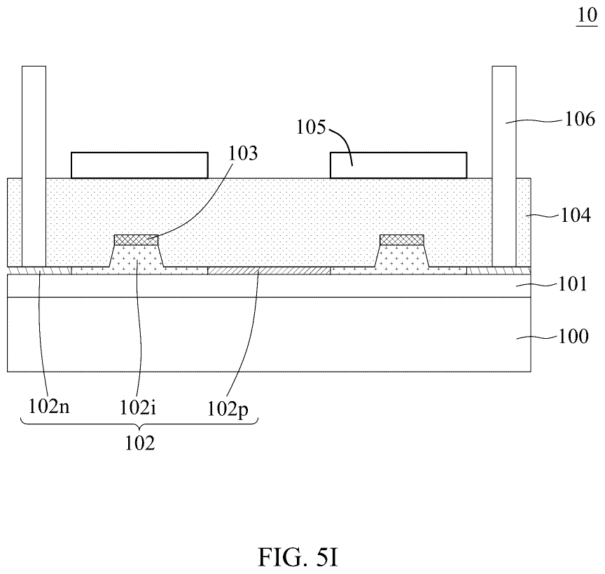

FIG. 5A to FIG. 5I illustrates a method of manufacturing a semiconductor device 10 according to some embodiments of the present disclosure.

Referring to FIG. 5A, the method for manufacturing a ring waveguide 10 includes providing a substrate 100. The substrate 100 may be a semiconductor substrate (e.g., a wafer). The semiconductor substrate 100 may be a silicon substrate. The substrate 100 may be pre-formed by a plurality of operations.

A dielectric layer 101 is formed on the substrate 100. The dielectric layer 101 may be silicon dioxide (SiO₂) (which may be formed in the presence of oxygen at a temperature in the range from 900° C. to 1380° C.). The dielectric layer 101 is a base dielectric layer.

The dielectric layer 101 may be formed by plasma-enhanced chemical vapor deposition (PECVD), HDP chemical vapor deposition or thermal oxidation operations. In some examples, the dielectric layer 101 may be a buried oxide (BOX) layer in the substrate 100. For example and depending on the application, a layer of the SiO₂ may be buried in the substrate 100 at a depth from the wafer surface ranging from less than 100 nm to several micrometers.

Subsequently, an intrinsic silicon layer 102i is deposited on the dielectric layer 101 through an epitaxy deposition by means of chemical vapor deposition (CVD) or molecular beam epitaxy (MBE). A thickness of the intrinsic silicon layer 102i may have a range from 30 nm to 70 nm. In some embodiments, the intrinsic silicon layer 102i is a base layer.

Referring to FIG. 5B, the intrinsic silicon layer 102i may include p-type highly doped portions. The dopant concentration may be around 1310¹⁸ cm⁻³ to 9310¹⁸ cm⁻³. A central portion of the intrinsic silicon layer 102i is doped to form a p-type doped portion 102p.

Referring to FIG. 5C, the intrinsic silicon layer 102i may include n-type highly doped portions. The dopant concentration may be around 1310¹⁸ cm⁻³ to 9310¹⁸ cm⁻³. A periphery portion of the intrinsic silicon layer 102i is doped to form an n-type doped portion 102n. In some embodiments, the order of the steps in FIG. 5B and FIG. 5C is exchangeable.

Referring to FIG. 5D, an additional intrinsic silicon layer 102i is epitaxially grown on the intrinsic silicon layer 102i. The additional intrinsic silicon layer 102i covers the n-type doped portion 102n and the p-type doped portion 102p.

Subsequently, a phase change material (PCM) 503 is deposited on the additional intrinsic silicon layer 102i. A thickness of the PCM 503 may have a range from 0.01 nm to 100 nm. In some embodiments, the PCM 503 is formed by chemical vapor deposition (CVD), physical vapor deposition (PVD), pulsed laser deposition (PLD), sputtering, atomic layer deposition (ALD), or any other suitable thin film deposition processes.

Next, a photoresist layer is formed on the PCM 503 and then patterned, using photolithography as a patterned photoresist layer 510.

Referring to FIG. 5E, the exposed portion of the PCM 503 and the additional intrinsic silicon layer 102i are etched, and the patterned photoresist layer 510 is removed. After the etching operation, a PIN structure 102 and a PCM layer 103 are formed.

The PIN structure 102 includes the n-type doped portion 102n, the p-type doped portion 102p, and an intrinsic portion 102i disposed therebetween. The intrinsic portion 102i has a base and a mesa. A thickness of the base of the intrinsic portion 102i, a thickness of the n-type doped portion 102n, and a thickness of the p-type doped portion 102p are substantially the same. A width of the PIN structure 102 may have a range from 600 nm to 1000 nm. A height of the mesa of the intrinsic portion 102i may have a range from 100 nm to 200 nm.

Referring to FIG. 5F, a dielectric layer 104 is formed on the PIN structure 102. The dielectric layer 104 may include silicon dioxide (SiO₂) (which may be formed in the presence of oxygen at a temperature in the range from 900° C. to 1380° C.). The dielectric layer 104 may be characterized by a relatively low thermal conductivity (about 1.4 W/(mK)), which is beneficial for thermal confinement.

The dielectric layer 104 may be formed by plasma-enhanced chemical vapor deposition (PECVD), HDP chemical vapor deposition or thermal oxidation operations. A thickness of the dielectric layer 104 may have a range from 200 nm to 800 nm.

Referring to FIG. 5G, a conductive layer 505 is formed on the dielectric layer 104. The conductive layer 505 may be a heater layer.

Referring to FIG. 5H, the conductive layer 505 is patterned to form a heater 105. The heaters 105 align with the PIN structure 102. The heaters 105 align with the PCM layer 103.

Referring to FIG. 5I, a plurality of conductive vias 106 are formed on the PIN structure 102 by photolithography, etching, and deposition operations. After that, the semiconductor device 10 is completed.

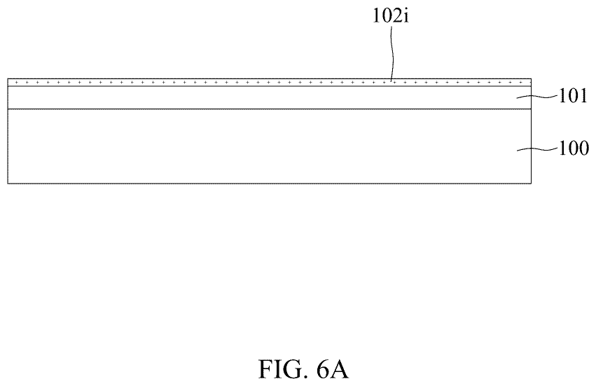

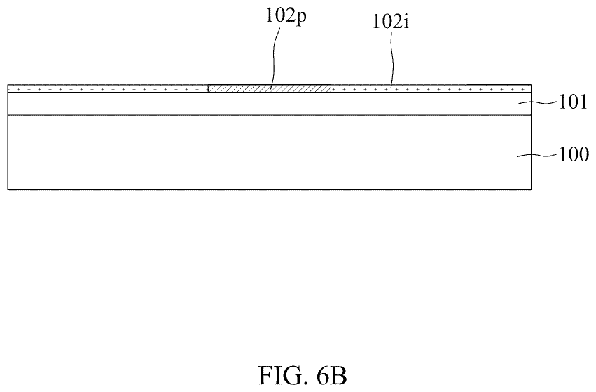

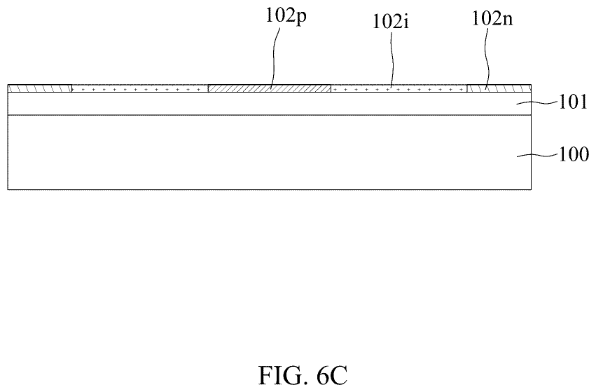

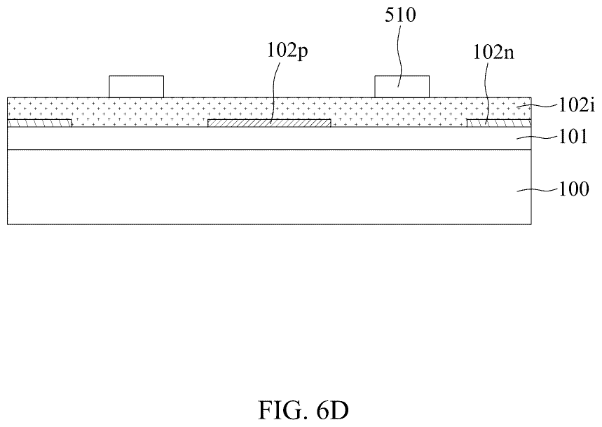

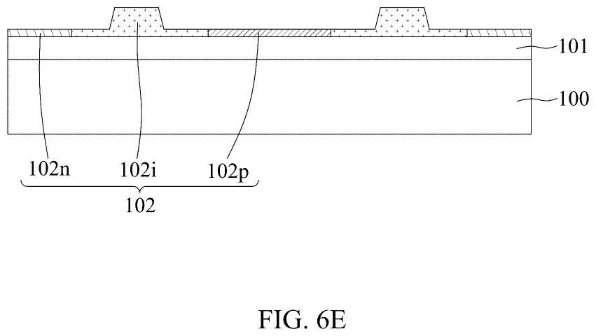

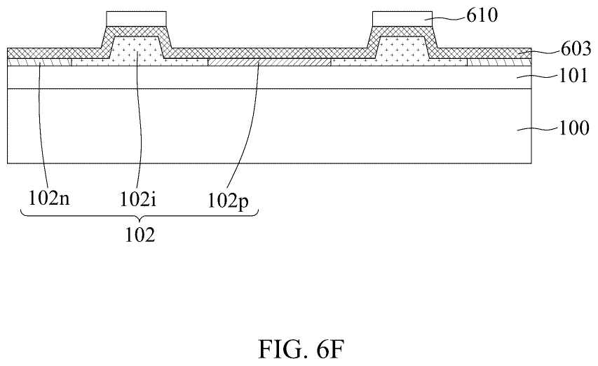

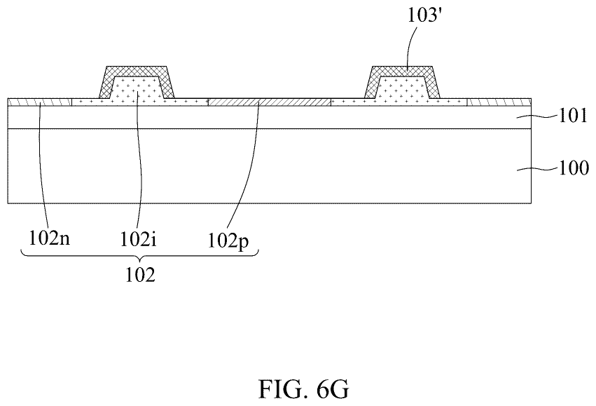

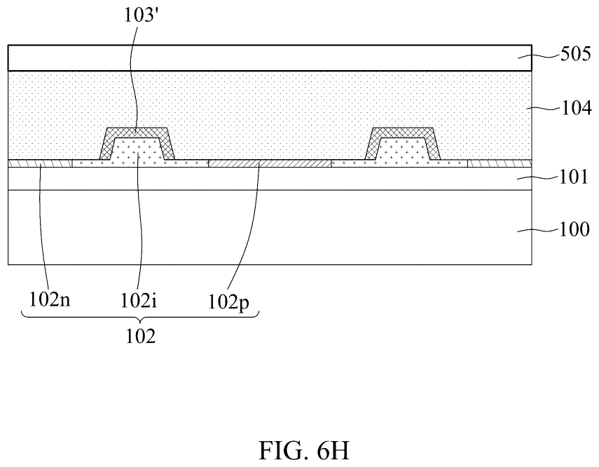

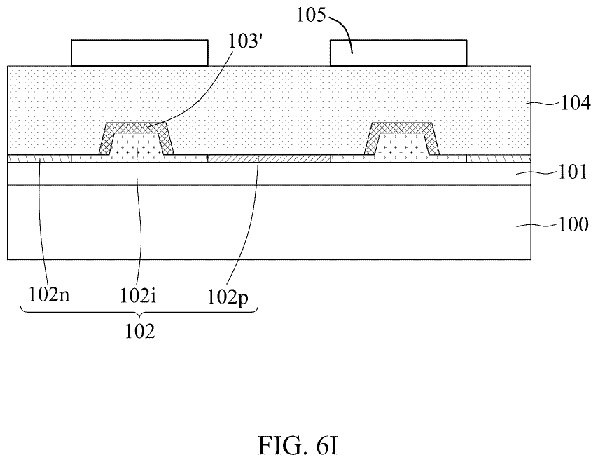

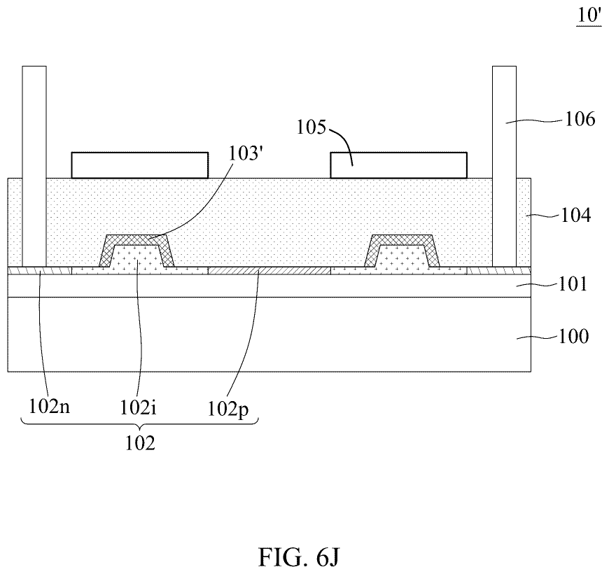

FIGS. 6A to 6J illustrate a method of manufacturing a ring waveguide 10′ according to some embodiments of the present disclosure.

Since the operations of FIGS. 6A to 6C are the same as those of FIGS. 5A to 5C, the operations of FIGS. 6A to 6C are omitted here.

Referring to FIG. 6D, an additional intrinsic silicon layer 102i is epitaxially grown on the intrinsic silicon layer 102i. The additional intrinsic silicon layer 102i covers the n-type doped portion 102n and the p-type doped portion 102p.

Subsequently, a photoresist layer is formed on the additional intrinsic silicon layer 102i and then patterned, using photolithography as a patterned photoresist layer 510.

Referring to FIG. 6E, an etching operation is performed to form a PIN structure 102. Then, the patterned photoresist layer 510 is removed.

Referring to FIG. 6F, a PCM 603 is deposited on the PIN structure 102.

Subsequently, a photoresist layer is formed on the PCM 603 and then patterned as a patterned photoresist layer 610 to cover the portion of the PCM 603 on the mesa.

Referring to FIG. 6G, the exposed portions of the PCM 603 is etched and the patterned photoresist layer 610 is removed. After the etching operation, a PCM layer 103′ is formed.

Regarding FIGS. 6H to 6J, since the operations of FIGS. 6H to 6J are the same as those of FIG. 5F to FIG. 5I, the operations of FIGS. 6H to 6J are omitted here. As shown in FIG. 6J, the ring waveguide 10′ is completed.

Some embodiments of the present disclosure provide a method for manufacturing a semiconductor device. The method comprises providing a substrate; depositing a first silicon layer on the substrate, the first silicon layer including a first type portion, a second type portion, and an intrinsic portion disposed therebetween; depositing a second silicon layer on the first silicon layer; depositing a phase change material on the second silicon layer; forming a photoresist on the phase change material; and etching the phase change material and the second silicon layer to form a silicon structure and a phase change material layer.

Some embodiments of the present disclosure provide a method for manufacturing a semiconductor device. The method comprises providing a substrate; forming a microring resonator modulator (MRM) on the substrate, the MRM including a first type doped portion, a second type doped portion, and an intrinsic portion disposed therebetween; forming a wavelength-adjusting component on the MRM; depositing a dielectric layer on the substrate to cover the MRM and the wavelength-adjusting component; and forming a heater on the dielectric layer, wherein the wavelength-adjusting component is configured to adjust a wavelength of an optical signal in the MRM based on energy received from the heater.

Some embodiments of the present disclosure provide a semiconductor device. The semiconductor device comprises a substrate, a first dielectric layer disposed on the substrate, a semiconductor structure disposed on the first dielectric layer, a phase change material layer disposed on the semiconductor structure, a second dielectric layer disposed on the first dielectric layer and covering the semiconductor structure and the phase change material layer, and a heater disposed on the dielectric layer. The phase change material layer is configured to receive heat from the heater to change from an amorphous state to a crystalline state.

The foregoing outlines structures of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for manufacturing a semiconductor device, comprising:
providing a substrate;
depositing a first silicon layer on the substrate, the first silicon layer including a first type portion, a second type portion, and an intrinsic portion disposed therebetween;
depositing a second silicon layer on the first silicon layer;
depositing a phase change material on the second silicon layer;
forming a photoresist on the phase change material; and
etching the phase change material and the second silicon layer to form a silicon structure and a phase change material layer.

2. The method of claim 1, wherein the phase change material includes any one of GeTe, GeSbTe₂₂₅, GeSbSeTe, VO₂, Sb₂S₃, and Sb₂Se₃.

3. The method of claim 2, wherein the phase change material includes any one of GeTe, GeSbTe₂₂₅, GeSbSeTe, VO₂, Sb₂S₃, and Sb₂Se₃ doped with carbon, nitrogen, Al, Ag, or W.

4. The method of claim 1, further comprising:
depositing a dielectric layer on the substrate to cover the silicon structure and the phase change material layer; and
forming a heater on the dielectric layer.

5. The method of claim 1, wherein etching the second silicon layer further comprises forming a silicon mesa on the intrinsic portion.

6. The method of claim 5, wherein the silicon mesa tapers from a bottom of the silicon mesa toward a top of the silicon mesa.

7. The method of claim 4, wherein forming the heater on the dielectric layer further comprises aligning the heater with the silicon structure.

8. The method of claim 7, wherein a width of the heater is substantial equal to a width of the intrinsic portion of the silicon structure.

9. The method of claim 4, wherein forming the heater on the dielectric layer further comprises aligning the heater with the phase change material layer.

10. The method of claim 9, wherein a width of the heater is substantial equal to a width of the phase change material layer.

11. A method, comprising:
providing a substrate;
forming a microring resonator modulator (MRM) on the substrate, the MRM including a first type doped portion, a second type doped portion, and an intrinsic portion disposed therebetween;
forming a wavelength-adjusting component on the MRM;
depositing a dielectric layer on the substrate to cover the MRM and the wavelength-adjusting component; and
forming a heater on the dielectric layer,
wherein the wavelength-adjusting component is configured to adjust a wavelength of an optical signal in the MRM based on energy received from the heater.

12. The method of claim 11, wherein the wavelength-adjusting component includes any one of GeTe, GeSbTe₂₂₅, GeSbSeTe, VO₂, Sb₂S₃, and Sb₂Se₃.

13. The method of claim 12, wherein the wavelength-adjusting component includes any one of GeTe, GeSbTe₂₂₅, GeSbSeTe, VO₂, Sb₂S₃, and Sb₂Se₃ doped with carbon, nitrogen, Al, Ag, or W.

14. The method of claim 11, wherein the wavelength-adjusting component covers an entirety of the intrinsic portion.

15. The method of claim 11, wherein the intrinsic portion includes a silicon mesa tapering from a bottom of the silicon mesa toward a top of the silicon mesa.

16. The method of claim 15, wherein the wavelength-adjusting component is in contact with a side surface of the silicon mesa.

17. The method of claim 12, wherein a first refractive index shifting sensitivity of the wavelength-adjusting component is greater than a second refractive index shifting sensitivity of the intrinsic portion.

18. The method of claim 12, wherein a first wavelength shifting sensitivity of the wavelength-adjusting component is greater than a second wavelength shifting sensitivity of the intrinsic portion.

19. A semiconductor device, comprising:
a substrate;
a first dielectric layer disposed on the substrate;
a semiconductor structure disposed on the first dielectric layer;
a phase change material layer disposed on the semiconductor structure;
a second dielectric layer disposed on the first dielectric layer and covering the semiconductor structure and the phase change material layer; and
a heater disposed on the dielectric layer,
wherein the phase change material layer is configured to receive heat from the heater to change from an amorphous state to a crystalline state.

20. The semiconductor device of claim 19, wherein the phase change material layer includes any one of GeTe, GeSbTe₂₂₅, GeSbSeTe, VO₂, Sb₂S₃, and Sb₂Se₃.
